(19) United States
(12) Patent Application Publication
(10) Pub. No.: US 2017/0228402 A1
(43) Pub. Date: Aug. 10, 2017

(54) Inconsistency Detection And Correction System

(71) Applicant: Microsoft Technology Licensing, LLC, Redmond, WA (US)

(72) Inventors: Sunil Kumar, Bellevue, WA (US); Rahul Khot, Redmond, WA (US); Minghui Xia, Sammamish, WA (US)

(21) Appl. No.: 15/018,280

(22) Filed: Feb. 8, 2016

(51) Int. Cl. G06F 17/30

(52) U.S. Cl. CPC G06F 17/30303

(57) ABSTRACT

Aspects of the technology are directed to systems and methods for mitigating inconsistencies in a knowledge base. An inconsistency is automatically detected and it is determined whether the inconsistency is based on a source error, such as bad data quality, or an over conflation error of an entity. If the inconsistency is based on a source error, the inconsistent data point is removed. If the inconsistency is based on an over conflation of an entity, the entity is split up into two separate entities.

### BACKGROUND

Databases, such as knowledge bases (KB), have grown in size due to the vast amount of data available on the Internet. When a user, for example, searches for information using a search engine or other tool, some type of knowledge base may be consulted to find the desired information. However, in many cases, because so much information is available, it is not uncommon that a data point from a first data source is inconsistent with a data point from a second data source. There are many reasons for this occurrence, including bad data quality from a data source that may not be as reliable as other data sources. Or irrelevant or incorrect information could be provided to a user if an entity is erroneously associated with a different entity. For instance, if a user is searching for information on a book but receives information on the author of that book, the returned information might not be useful to the user.

Solutions for correcting inconsistencies in a database are typically heavily human dependent. While rules may be used to detect inconsistencies, this is likely not an automated process that can also be trained to fix the detected inconsistencies. The fix, if not readily apparent which data is incorrect, can be extremely computationally intensive, taking an extraordinary amount of time and effort with heavy human involvement.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects provided herein enable inconsistencies in a knowledge base or other database to be mitigated. Inconsistencies of different types are automatically detected and fixed based, in part, on a set of rules. An inconsistency could be data that is bad quality that was received from a particular data source. Alternatively, the inconsistency could be an over conflation of entities, where two entities were erroneously associated with one another when they should have been kept separate. The fix for these inconsistencies may depend upon the type of inconsistency as well as many other factors, including the data source from which the data was obtained, the value of other data points, data collected from other sources, and the like.

### BRIEF DESCRIPTION OF THE DRAWINGS

Aspects of the technology described in the present application are described in detail below with reference to the attached drawing figures, wherein:

FIG. 1 is a block diagram of an exemplary computing environment suitable for implementing aspects of the technology described herein;

FIG. 2 is a flow chart of a method for mitigating inconsistency errors in a knowledge base, in accordance with an aspect of the technology described herein;

FIG. 3 is a table illustrating exemplary errors and causes for those errors, in accordance with an aspect of the technology described herein;

FIG. 4 is a diagram of a portion of an exemplary knowledge base, in accordance with an aspect of the technology described herein;

FIGS. 5-7 illustrate flow diagrams of methods for mitigating inconsistency errors in a knowledge base, in accordance with aspects of the technology described herein; and

FIG. 8 is a block diagram of an exemplary computing environment suitable for implementing aspects of the technology described herein.

### DETAILED DESCRIPTION

The technology of the present application is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

Embodiments provided herein enable inconsistencies detected in a database, such as a knowledge base, to be automatically fixed based on statistical learning techniques. Inconsistent information may enter a KB, for example, either due to bad data quality from the data source or due to wrong conflation of entities from different sources. For example, for a source error, a conflict could be a timeline of a person entity, such as the data of birth and the data of death. A simple rule to detect inconsistencies could be that a person's date of death needs to come after the date of birth in time. Without an automated system as described further herein to automatically mine the rules, detect inconsistencies, and fix the inconsistencies, it would not be possible to mitigate inconsistencies in a knowledge base based on the enormous size and amounts of data in the knowledge base. Further, it is difficult even for a human to determine how to fix an inconsistency, as the inconsistency could be one of a number of different types of inconsistencies. Thus, an automated fix as described herein would be advantageous for many reasons.

As used herein, a knowledge base is a technology used to store complex structured and unstructured information used by a computer system. In the context of this technology, KB is a collection of facts about objects that corresponds to physical or metaphysical entities in the real world.

Existing techniques traditionally have applied a database against a known set of rules, such as inconsistency rules. Additionally rules may be explored via forward/backward chaining and deductive reasoning. However, these solutions typically require a large amount of human involvement, such as hand-picking inconsistencies and determining how to fix the inconsistencies. Using aspects provided herein, the rule base is automatically mined by training it on existing facts or data in the knowledge base. Further, aspects herein operate on fuzzy constrains unlike many existing approaches, which contain hard constraints. This allows for better precision and recall in inconsistency detection. Also unlike many existing solutions, aspects herein provide for evaluating the detected inconsistencies as potentially being tolerable by measuring their end-user impact. This could be accomplished, for example, by using intervals and thresholds to confirm whether data is inconsistent (not tolerable) or not (tolerable). This is advantageous as the system is able to focus on more serious inconsistencies.

Utilizing aspects herein, inconsistencies can be divided into at least two types. A first type of inconsistencies is due to bad data quality from a data source. A second type of inconsistencies is due to conflation of two different entities. For example, person(x)̂location(x) is an inconsistent pair of relations since an entity cannot be a person and a location at the same time. The fix is different for these different types of inconsistencies. For instance, for bad data quality, the inconsistent data can be discarded from the knowledge base to correct the inconsistency. For over conflation of entities, the fix may be to separate the entity into at least two separate entities. In some instances, the discarded data is retained for a certain amount of time in a repository where it can be further analyzed and used by a ranker, for instance, to learn about data that has been determined to be inconsistent. The value of the discarded properties can be predicted as well.

As mentioned, aspects herein may be utilized in conjunction with a knowledge base, which may be a web scale triple store that can be represented as a labeled direct graph where each entity, x, is a node, each binary relation, R(x,y), is an edge labeled R between x and y (y is another entity or a metadata value), and each unary relation, C(x), maps node x to a concept (e.g., person, location, organization). Aspects herein implement a trainable inference method that is able to learn to infer logically inconsistent sets of relations by combining the results of different random walks through the knowledge base. The inconsistent sets of relations enter the knowledge base either due to bad data quality of the data sources or due to wrong conflation of entities from different sources.

The system herein is scalable, and thus the complexity may depend on a number of hops of inconsistencies computed. For example, a one-hop logically inconsistent pair of relations is: person(x) ̂ date_of_birth (x,1-1-1970)̂ date_of_death (x, 1-1-1960), which indicates that the person entity x has a date of death earlier than his date of birth. An example of a two-hop logically inconsistent pair of relations is: person(x)̂ person(y)̂ date_of_birth (x, 1-1-1970)̂marriage (x,y)̂date_of death (y, 1-1-1960), which indicates that person entities x and y cannot be married to each other if y's date of death is before x's date of birth.

While there are many advantages to the systems and methods described herein, a considerable advantage is the reduced computation time needed for this automated detection and fix of inconsistencies in a knowledge base. Without the need for a human to detect inconsistencies and manually delete the incorrect data, the process can work much faster and on a higher level. Thus, data provided to a user who is, for example, using a search engine to search for something in particular, is more likely to receive data that has been found to be consistent and correct, instead of receiving inconsistent information that may not make sense.

According to a first aspect, a computing device is provided that comprises at least one processor and memory having computer-executable instructions stored thereon that, based on execution by the at least one processor, configure the at least one processor to mitigate inconsistency errors in a knowledge base. The computer-executable instructions are configured to automatically detect an inconsistency of a data point associated with an entity in the knowledge base, determine whether the inconsistency is based on a source error or an over conflation error of an entity, and resolve the inconsistency in accordance with determining whether the inconsistency is the source error or the over conflation error. When the inconsistency is determined to be based on a source error, the computer-executable instructions are configured to remove the inconsistent data point if it is determined that a data source from which the data point originated is less authoritative than another data source from which another data point originated. If it is not determined that the data source is less authoritative than the other data sources, the computer-executable instructions are configured to remove the inconsistent data point if there are more data points in the knowledge base that are consistent with the other data point than with the data point. If there are not more data points in the knowledge base that are consistent with the other data point than with the data point, the computer-executable instructions are configured to determine that data samples from one or more third-party data sources indicate that the other data point is accurate. When the inconsistency is determined to be based on an over conflation error, the resolving comprises separating the entity into two or more entities in the knowledge base.

According to a second aspect, a method is provided for mitigating inconsistency errors in a knowledge base. The method comprises automatically detecting an inconsistency of a data point associated with an entity in the knowledge base, and determining that the inconsistency is based on an over conflation error of an entity rather than a source error. For the entity in the knowledge base associated with the data point, the method comprises determining whether a first entity type and a second entity type associated with the entity are to be associated with the entity by analyzing entity type pairs in the knowledge base to determine whether the first entity type and the second entity type commonly occur together. Further, the method includes determining that the first entity type and the second entity type do not commonly occur together in the knowledge base, and correcting the association of the first entity type and the second entity type with the particular entity by separating the entity into a first entity having the first entity type and a second entity having the second entity type.

According to a third aspect, a method is provided for mitigating inconsistency errors in a knowledge base. The method comprises, for a particular entity in the knowledge base, identifying a first data point from a first data source. The method also comprises determining that the first data point is inconsistent with at least a second data point from a second data source and correcting the inconsistency in regards to the first data point. The correcting comprises removing the first data point from the knowledge base if (1) it is determined that the second data source is more authoritative than the first data source, (2) there are more data points in the knowledge base that are consistent with the second data point than with the first data point, or (3) data samples from one or more third-party data sources indicate that the second data point is accurate.

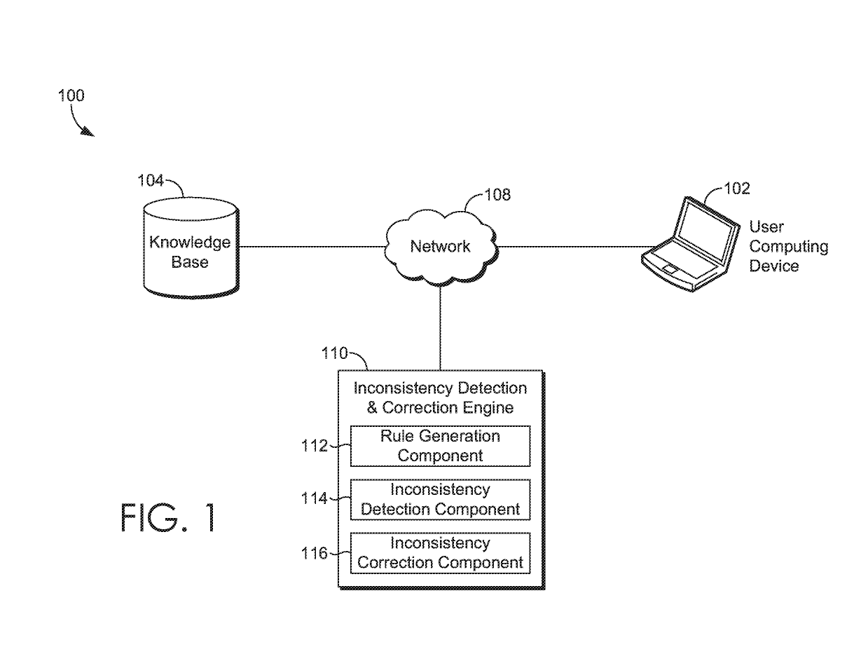

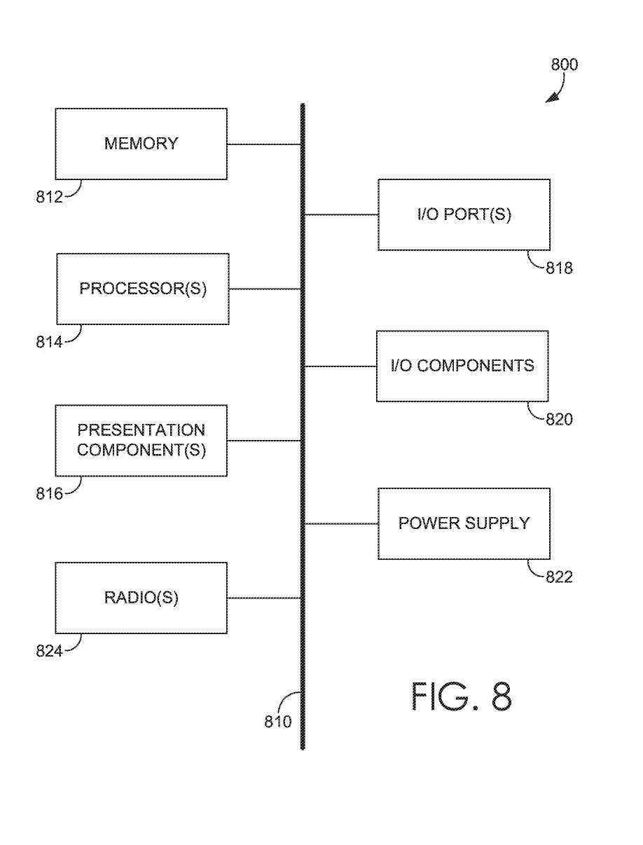

Turning now to FIG. 1, a block diagram 100 is illustrated of an exemplary operating environment in which embodiments described herein may be employed. As shown here, a user computing device 102 may be utilized by a user to conduct a search, or otherwise acquire information via the web. For instance, a particular user may have a mobile device, a laptop, a desktop computing device, or the like, that the user uses in different circumstances to search for information. For example, a user may use a search engine to search for particular information. The user computing device 102 could be any type of computing device, such as computing device 800 described herein in relation to FIG. 8. Additional examples of computing devices include bands, glasses, watches, televisions, and any other device capable of communications with the Internet. User computing device 102 may include code that can be used to run a personal digital assistant program. A personal digital assistant may provide services traditionally provided by a human assistant. Digital assistants may respond to voice commands or typed commands, and may provide typed or audible responses. In embodiments herein, the user computing device 102 may be used to obtain many different types of information. As can be expected, a user, when searching for information, wants to be able to use the user computing device 102 to receive information over the web that is accurate.

Block diagram 100 further includes a knowledge base 104 and an inconsistency detection and correction engine 110. Block diagram 100 further includes network 108, which may be wired, wireless, or both. In embodiments, the knowledge base 104, and the inconsistency detection and correction engine 110 communicate and share data with one another by way of network 108. Network 108 may include multiple networks, or a network of networks, but is shown in simple form so as not to obscure aspects of the present disclosure. By way of example, network 108 can include one or more wide area networks (WANs), one or more local area networks (LANs), one or more public networks, such as the Internet, and/or one or more private networks. Where network 108 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 108 is not described in significant detail.

The components mentioned above and illustrated in FIG. 1 may work together, according to aspects herein, to mitigate inconsistencies in a knowledge base 104. While a knowledge base 104 is illustrated in FIG. 1 and described throughout, other types of data stores are contemplated as well. Any type of a database, for instance, could include inconsistencies that could be similarly detected and removed using aspects provided herein.

The inconsistency detection and correction engine 110 comprises a rule generation component 112, an inconsistency detection component 114, and an inconsistency correction component 116. Generally, the inconsistency detection and correction engine 110 is responsible for automatically detecting inconsistencies in the knowledge base, and also automatically fixing these inconsistencies. The inconsistencies contemplated herein could include an inconsistency of a data point in the knowledge base. This could include a data value associated with an entity, where the data value is inconsistent with other data values in the knowledge base. As used herein, an “entity” generally refers to an instance of an abstract concept or object, including, for instance, a person, an event, a location, a business, a movie, and the like. For example, an entity can refer to a type of person such as an author, politician, or sports player; a type of product such as a movie, book, or a consumer good; or a type of place such as a restaurant, hotel, recreation area, or retail store. In aspects, entities may have relationships to other entities (e.g., a person entity may have a relationship with another person entity that is a spouse of the person entity, or a furniture item entity may have a relationship with other furniture item entities having the same manufacturer or style as the furniture entity).

For a particular entity, one or more inconsistencies may be automatically detected, in accordance with aspects herein. For example, for a particular person, that person's date of birth could be listed as both Jan. 5, 1975 and Jan. 5, 1976. One of these dates is obviously incorrect, and as such, one is inconsistent with the other. Or an inconsistency could include the failure of a data point to correspond to a predetermined rule. For example, a rule used to detect for inconsistencies could be that a person's date of birth is earlier in time than the person's date of death. If, for a particular person, it is found that his date of birth is Jan. 5, 1970, but his date of death is Jan. 5, 1969, this is obviously inconsistent. While the date of birth/date of death example of a rule is provided, it is noted that there are many rules that could be used to detect inconsistencies. Even further, an inconsistency could occur if two entities are associated with one another in a knowledge base when they should actually be separated. For example, it could be determined that a “person” entity type and a “book” entity type are very rarely found together as being associated in the knowledge base. If the correlation between “person” and “book” is below a certain threshold, the entity having both of these entity types may be split up so that there is a “person” entity and a “book” entity.

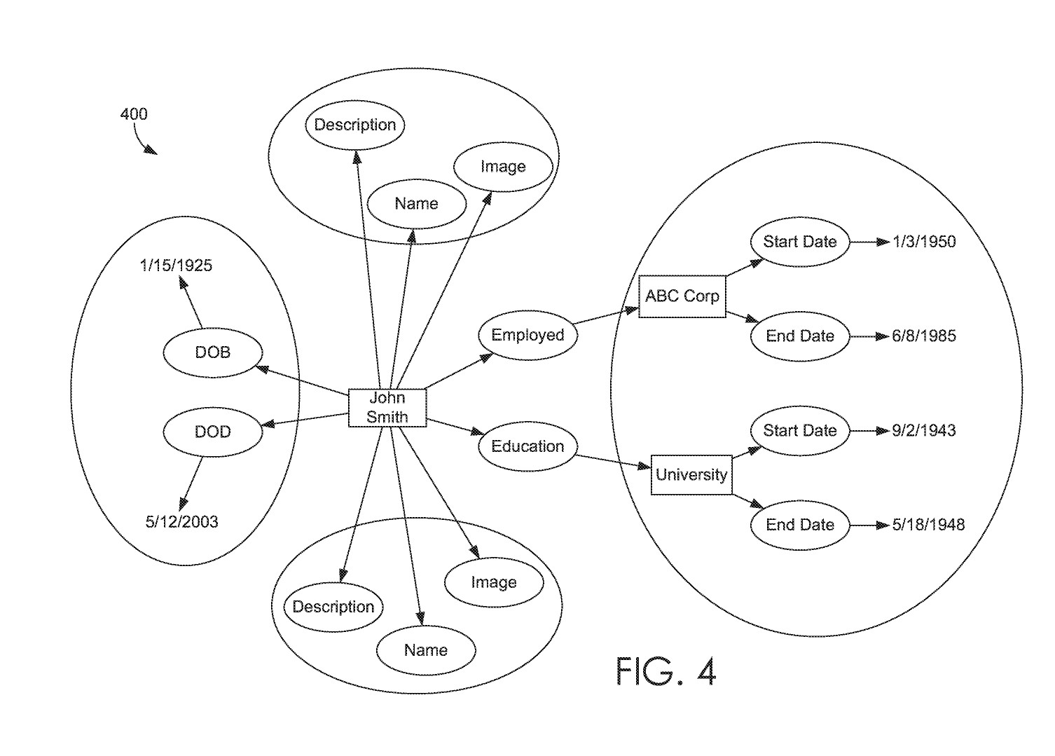

A “knowledge base,” as used herein, such as knowledge base 104 of FIG. 1, refers to relational databases including domain databases, knowledge graphs, or similar information sources. In one embodiment, a knowledge base comprises a structured semantic knowledge base such as the Semantic Web. By way of background, the Semantic Web (or similar structured knowledge bases or web-scale semantic graphs) can be represented using the Resource Description Framework (RDF), which is a triple-based structure of association that typically includes two entities linked by some relation and is similar to the well-known predicate/argument structure. An example would be “produced_by (Mission: Impossible—Ghost Protocol, Tom Cruise).” As RDFs have increased in use and popularity, triple stores (referred to as knowledge bases or knowledge graphs) covering various domains have emerged, such as Freebase.org. In one embodiment, a knowledge base may include one or more knowledge graphs (or relational graphs), which include sets of triples indicating a relation between two entities (e.g., Mission: Impossible—Ghost Protocol—produced by—Tom Cruise), and which may be compiled into a graph structure. An exemplary knowledge graph is provided in FIG. 4, which illustrates exemplary entities and their relationships, and will be discussed in greater detail herein.

In one instance, the knowledge base identifies at least one entity. As used herein and as mentioned above, the term “entity” is broadly defined to include any type of item, including a concept or object, that has potential relationships with other items. For example, an entity may include the shoe “Minka 100,” the designer “Jimmy Choo,” and the website “www.jimmychoo.com.” These three entities are related, in that the shoe “Minka 100” is designed by Jimmy Choo, and can be purchased on the Jimmy Choo website. Multiple entities related in some manner typically comprise a domain, which may be considered as a category of entities, such as movies, exercise, music, sports, businesses, products, organizations, etc.

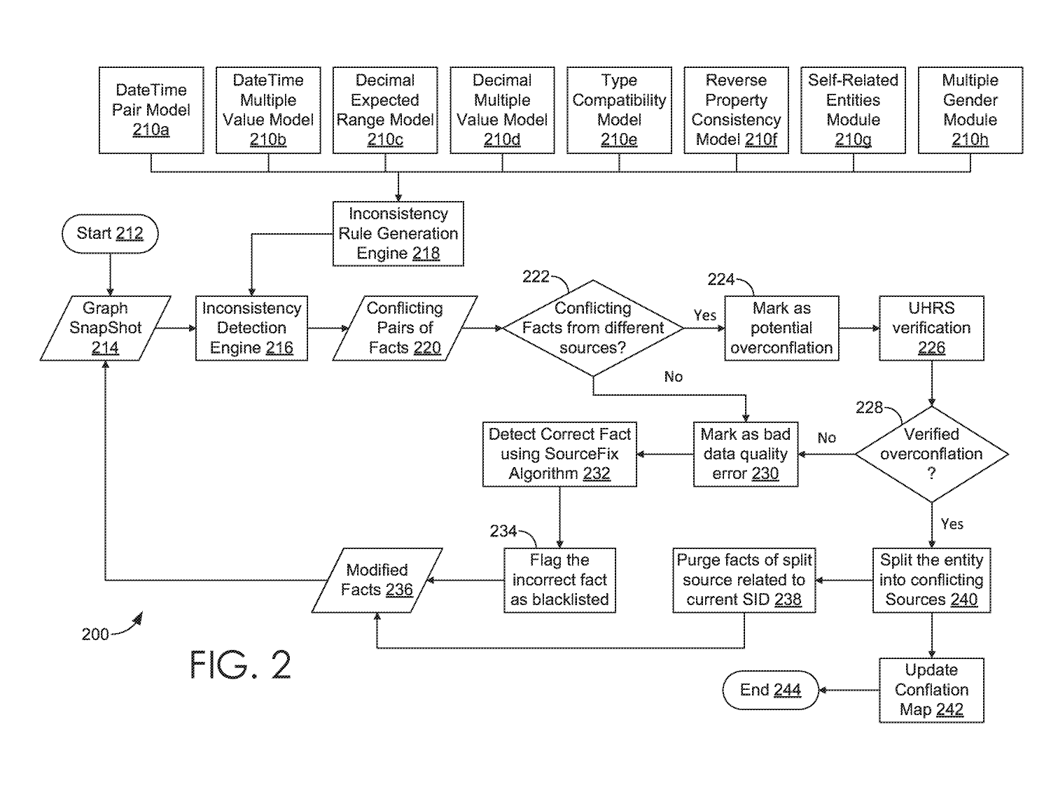

Generally, the rule generation component 112 is responsible for generating a plurality of rules that can be used by the system by applying the rules to the data in a knowledge base. One exemplary rule that may be generated by the rule generation component 112 is that a person's date of birth should come before that person's date of death. If this rule is applied and certain data fails the rule, there may be an inconsistency in that person's date of birth, date of death, or both. Other rules may be applied to look for other types of inconsistencies, and will be discussed in more detail herein in regards to FIG. 2.

The inconsistency detection component 114 is generally responsible for detecting inconsistencies in a knowledge base 104. As mentioned, rules are generated by the rule generation component 112 to determine where an inconsistency may be present in a knowledge base 104. The inconsistency detection component 114, in aspects, may determine whether something tagged as potentially being inconsistent is actually an inconsistency, such as whether it is enough of an inconsistency to take corrective action. In one aspect, a threshold value is used such that when the difference between a potentially inconsistent value and other values thought to be correct is above the threshold, it can be confirmed by the inconsistency detection component 114 that the potentially inconsistent value is inconsistent. Thresholds may be used in different ways as well to filter out inconsistent data from data that may not be exactly consistent, but that is close enough to be kept in the knowledge base 104. In some aspects, a threshold may be determined to be a certain percentage of a minimum value, where anything more than that percentage above/below the minimum value is considered to be an inconsistency. In other cases, the threshold could be a particular value. For instance, if a person's height from different sources is listed as 5′1″, 5′1.5″, and 5′11″ and the threshold value is 1″, the 5′1″ and 5′1.5″ may be determined to be consistent with one another, but the 5′11″ would likely not be found to be consistent, and may be flagged as being inconsistent.

In aspects, the inconsistency detection component 114 may do more than just determine where inconsistencies exist. For example, this component may perform several steps, depending on which type of data it is currently inspecting. For dates that exist in the knowledge base 104, entities may first be identified that have dates associated therewith. When an entity is identified that has an associated date, properties such as date types are identified. These types of dates could include a movie release date; an open and close time of a restaurant, store, or other business; a date of birth; a date of death; and the like. When multiple dates are found, the inconsistency detection component 114 may compute how many times a first date type and a second date type are associated with a single entity. For instance, for a person entity, a date of birth and a date of death are highly correlated, and thus it would be found that these date types are typically found together for a single entity, a person. When a person entity has a date of death, it is highly likely a date of birth will also be found. For a restaurant, store, or other business, an open time and a close time are highly correlated. In short, pairs of properties, here dates, are found that are associated with the same entity. With pairs of properties having been identified, a mean value (distance) and a standard deviation are computed. From these two values, an interval is created, the lower end and the higher end being one of the mean value or the standard deviation. Outside this interval, a value may be considered to be inconsistent. This interval is created such that the system is very confident that a value inside of the interval is consistent. A similar process can be used for other numeric values, such as decimal values, a height of a person/object, length of a river, etc.

In other aspects, a wide source of data is inspected to identify potential inconsistencies in a knowledge base. For example, if 1000 different restaurants are surveyed and most have opening and closing times on a Friday that would lend the restaurants being open in a range of 8-12 hours that day, and then one of the restaurants is found to be open 22 hours on a Friday based on its open and close times, these open and close times may be flagged as potentially being inconsistent.

Another type of inconsistency detection performed by the inconsistency detection component 114 is type compatibility. Two entity types may have previously been associated with one another, and for various reasons, it may be determined that these entity types should not be combined. For example, it could be determined that a person could be an athlete, an actor, a director, a producer, an engineer, etc., but that a person could not be a book. For a person entity type and a book entity type to be combined into a single entity would make it confusing when a knowledge base 104 is being searched by a search engine or other application for information about that person. In one aspect, the knowledge base 104 is surveyed to determine which entity types most often are associated with one another. Using Tom Cruise as an example again, Tom Cruise is a person, an actor, a film producer, and a film director. If surveyed, it could be found from the knowledge base 104 that a person has a high correlation of being associated with an actor, a film producer, and a film director. These entity types, in one aspect, would not be separated if they were found to be correctly associated with one another. Jimmy Choo, on the other hand, is a person, a designer, and a brand. While it may be found that a person entity type has a high correlation of being associated with a designer entity type, it could also be found that a person entity type has a low correlation of being associated with a brand entity type. When a user searches to find information on Jimmy Choo shoes, that person is likely not looking for information about Jimmy Choo, the person. Likewise, when a user is searching for personal information regarding Jimmy Choo (e.g., age, place of birth), the user is likely not wanting information on pricing for Jimmy Choo shoes. For this reason, the system could find that Jimmy Choo as a person entity type should be a separate entity from Jimmy Choo as a brand entity type.

Another example is the organism classification (biological) of something and a food dish (biology.organism_classification ---- food.dish). Salmon, for example, is an organism as well as a food dish. The same entity, salmon, could reasonably be associated with both an organism classification and a food. As such, a food dish and an organism classification may have a high correlation to one another. On the other hand, a location and a food ingredient (Location.location ---- food.ingredient) may not be highly correlated to one another. For instance, Java could mean coffee beans as well as an island in Indonesia. Java is a different entity in these two cases.

Another example further exemplifies the difference between entity types that have a high correlation and entity types that have a low correlation to one another. There is a high correlation between a person and an organism. Here, an organism is a super class of a person. The correlation between a person and an organism could be at least 99%. It is expected that a person would also be an organism. On the other hand, the correlation between a person and an organization (e g, Jimmy Choo as a person and Jimmy Choo as a company) is likely to be pretty low. When surveying a knowledge base 104, it may not be found very often that a person is also an organization. Therefore, in some aspects, a person entity type and an organization entity type are inconsistent, whereas a person entity type and an organism entity type are consistent.

To illustrate this using a different example, there are times when a book title is also a movie title, such as a movie being made that is based on a book. The Hunger Games, for example, is a movie that is based on a book. While there is common information between the book and movie, they are not the same thing. It could be confusing, if they are represented in the knowledge base 104 as the same entity, to determine whether a user wants to find information about the book or movie. Even more, information for the movie may come from a movie site, such as Netflix, whereas information for the book may come from Wikipedia, for example. This is likely to cause conflicting information in the knowledge base 104.

The inconsistency correction component 116 is generally responsible for correcting any inconsistencies found in the knowledge base 104 by, for example, the inconsistency detection component 114. As mentioned, there are different types of inconsistencies that can be detected in a knowledge base 104. A data point could be wrong, such as by poor data quality, or entity types could be associated when they should not be. When entity types are associated when they should not be, the fix is simply to divide the entity into two separate entities. Using the above examples, The Hunger Games could be divided into a The Hunger Games book entity and a The Hunger Games movie entity Jimmy Choo could be divided into a Jimmy Choo designer entity and a Jimmy Choo company entity.

When an inconsistency is based on incorrect data, there are several options that could be used individually or in combination to correct the inconsistency. Initially, when there is data from a first source and data from a second source and the data values are inconsistent, it could be determined whether one of the sources is more authoritative than the other. If so, the fix may be to delete the data from the less authoritative source and keep the data from the more authoritative source. In the case that one source cannot be determined to be more authoritative than another, cross validation could be utilized. For example, a set of data points could be compared to one another to determine which data value more often is found in the knowledge base. If there are five data points from five different sources, and three of the five data points have the same or similar values, it could be determined that the other data points are inconsistent, and thus would be discarded from the knowledge base 104. This institutes the concept of “majority rule.” The same process could be performed with any number of data points. If, however, there is no clear majority of data points, samples could be collected from various third-party data sources. If, for example, the date of birth and date of death are inconsistent for a particular entity, samples of dates of birth and death for that person could be collected from external data sources. In one aspect, 100 data samples are collected from one or more third-party data sources to determine which data value these samples point to. This indicates which data value is correct, and thus consistent. In one case, if multiple third-party data sources are used to collect samples, a rule could be created to use data collected from a particular source that is known to be more authoritative than others. This process could be iterative and a learning process, whereas the system could gradually learn which sources to trust based on which is more often chosen as having consistent data.

In some instances, any data that is discarded from the knowledge base 104 due to inconsistencies is kept in a data store or repository for future use. For example, in some aspects, a ranking component may use this discarded information as a learning tool to understand which information to keep and which to discard. Alternatively, if data, such as a fact, is discarded as being inconsistent but consistent data cannot otherwise be found to include in the knowledge base 104, this is another reason that the inconsistent data may be stored.

The knowledge base 104 may actually be multiple data stores, such as a series of data stores, that are connected to one another, or that are not connected to one another, and therefore not able to communicate to each other. Even further, while the inconsistency detection and correction engine 110 is shown as a single engine, it could be a series of engines (e.g., hardware components) that work together to provide the inconsistency detection and correction services, as described herein.

Turning now to FIG. 2, FIG. 2 is a flow chart of a method 200 for mitigating inconsistency errors in a knowledge base, in accordance with an aspect of the technology described herein. At item 212, the process starts. A snapshot of the graph (e.g., knowledge base) is taken at item 214. This snapshot is provided to the inconsistency detection engine 216. Items 210a-210h illustrate various models from which inconsistencies can be detected. For instance, examples provided above have included those that have pairs of dates or times, such as a date of birth and date of death, or an open time and close time of a business. These pairs would correspond to the DateTime Pair Model 210a. The type consistency discussed previously here determines whether entity types that are associated with one another are inconsistently associated. This corresponds to the Type Compatibility Model 210e (e.g., music.group, people.person). Other models include the DateTime Multiple Value Model 210b, the Decimal Expected Range Model 210c (e.g., mountain height >9000 meters), the Decimal Multiple Value Model 210d (e.g., people.person.height), the Reverse Property Consistency Model 210f (e.g., if A is an author of book B, then book B should be authored by A), the Self-Related Entities Model 210g (e.g., S is a parent of itself), and the Multiple Gender Model 210h. As an example of data inconsistencies using the Multiple Gender Model 210h, a particular person could be listed as both a female and a male, which may be flagged as an inconsistency. The inconsistency rule generation engine 218 may perform similar functions as those described above in regards to the rule generation component 112. For instance, the models 210a-210h may feed information to the inconsistency rule generation engine 218 to enable the inconsistency rule generation engine 218 to generate rules that are applied to the knowledge base, such as knowledge base 104 of FIG. 1. An exemplary rule for the DateTime Pair Model 210a is that a date of death is to occur after a date of birth. It will become apparent that many different types of rules can be generated by the inconsistency rule generation engine 218.

The inconsistency detection engine 216 may perform functions similar to those described above in regards to the inconsistency detection component 114 of FIG. 1. In one aspect, the inconsistency detection engine 216 applies rules to the data in the knowledge base. Initially, the inconsistency detection engine 216 may detect potential inconsistencies, and then confirm whether a data point is inconsistent or not. As mentioned, the inconsistency detection engine 216 may utilize computed thresholds to determine whether a value, for instance, is within an acceptable range of the consistent data to be kept in the knowledge base and not discarded. Alternatively, an interval can be computed for pairs of properties that are associated with the same entity. The interval, in aspects, is computed from the mean value and the standard deviation of the data. If a particular data point is outside of that interval, it may be considered inconsistent.

As shown in FIG. 2, conflicting pairs of facts 220 are identified. At step 222, it is determined whether the conflicting facts are from different sources. If the conflicting facts are not from different sources (e.g., a single source), the data is marked or flagged as being a bad data quality error 230. If the conflicting facts are from different sources, the data is marked as potentially being over conflated 224. At step 226, (UHRS) verification may occur. It is determined at step 228 whether the over conflation has been verified. If it has been verified, the entity is split into separate entities based on the conflicting sources 240. If over conflation is not verified, the data is marked as being a bad data quality error 230. Now that the data has been confirmed to be of bad quality, an algorithm may be used at step 232 to detect the correct or consistent data. The inconsistent data is flagged at step 234 as being blacklisted, and the data is modified at step 236. This modified data is then fed back into the knowledge graph and into the next graph snapshot taken at 214. Reverting back to the entities being split by conflicting sources at 240, the facts/data of the split source are purged at 238 and sent to be modified, as needed, at 236. Once the entities have been split into separate entities, the conflation map is updated at 242, and the process ends at 244.

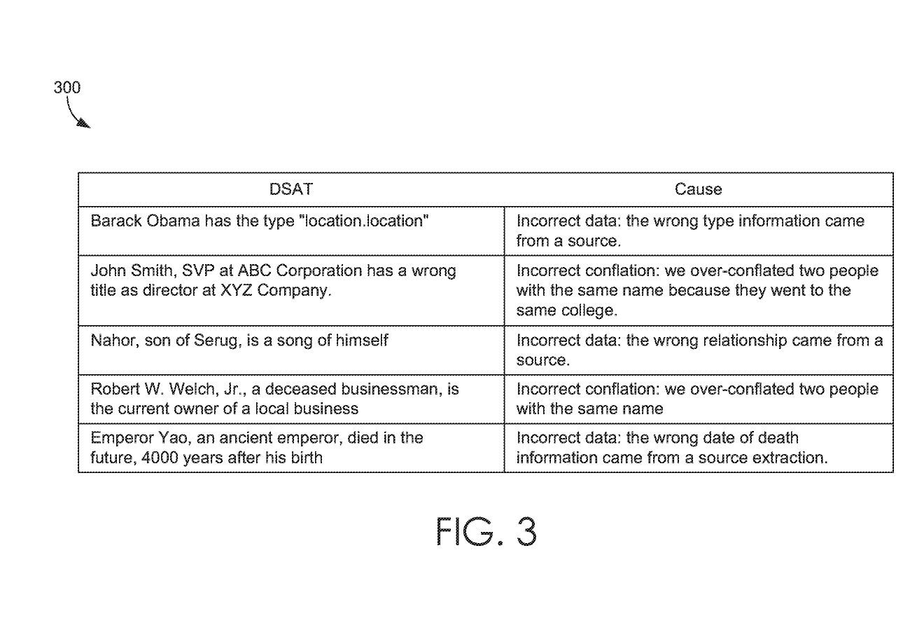

FIG. 3 is a table illustrating exemplary errors and causes for those errors, in accordance with an aspect of the technology. The errors and inconsistent data illustrated in FIG. 3 is provided for exemplary purposes only, and is not meant to be limiting in any way. Initially, the entity “Barack Obama” has the entity type of location. While Obama is a person, he is certainly not a location. The cause, as shown here, could have been from a source that provided bad quality data. Another example is a person, John Smith, who is a Senior Vice President of ABC Corporation. However, a knowledge base also says the same John Smith is the director of XYZ Company. The cause for this could be incorrect conflation, where two people with the same name were over conflated because they went to the same college. Still yet another example is that Nahor is a person (son of Serug) but is also a song. This could have been caused by an incorrect relationship from a source. Another example is a businessman who is deceased, but is listed as the current owner of a business. One potential cause for this is that two people having the same name were over conflated. The last example in the table of FIG. 3 is Emperor Yao who has a date of death that is 4000 years after his date of birth. Here, incorrect data caused the inconsistent information, as the wrong date of death may have come from a particular source.

Referring to FIG. 4, a diagram is illustrated of a portion of an exemplary knowledge base, in accordance with an aspect of the technology described herein. Random walks may be taken through a knowledge base to discover rules, and to compute pairs or sets of data that most commonly occur. The portion of the knowledge graph illustrated in FIG. 4 is for entity “John Smith” who has a listed date of birth, date of death, work employment dates, and education dates. A walk through of this portion of the knowledge graph may provide a list of traversed properties along the path. In aspects, a walk is performed by starting from a node, and ending on a leaf node (a value such as a string, decimal number, date/time, etc.).

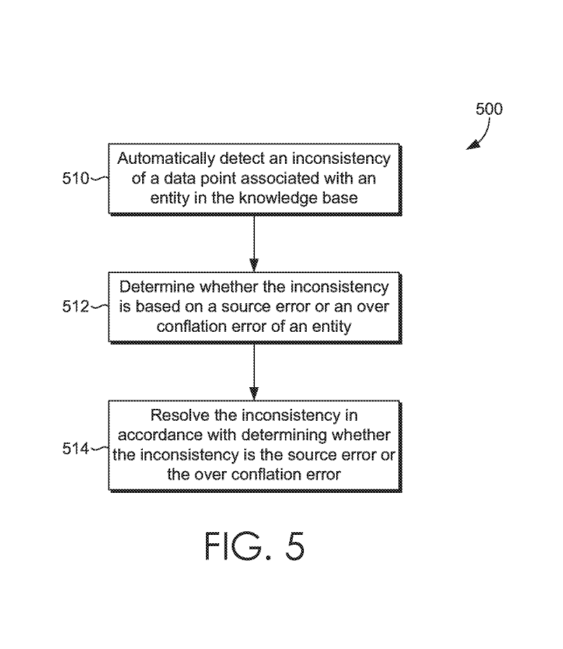

FIG. 5 illustrates a flow diagram of a method 500 for mitigating inconsistency errors in a knowledge base, in accordance with aspects of the technology described herein. Initially, at block 510, an inconsistency of a data point associated with an entity in a knowledge base is automatically detected. In an aspect, the inconsistency of the data point associated with an entity in the knowledge base is automatically detected when the data point is not in compliance with a predetermined rule. A data point could be, for example, a value, a relationship between two entities, an association between entities or entity types, etc. At block 512, it is determined whether the inconsistency is based on a source error or an over conflation error of an entity. In an aspect, the inconsistency is based on a source error when the data point is associated with a single data source, such as when bad quality data is received from a particular source. On the other hand, the inconsistency may be based on an over conflation error when the data point is associated with a plurality of data sources. As described herein, over conflation is used to refer to an entity being erroneously associated with a first entity type and a second entity type, when the entity should be divided into two separate entities, the first having the first entity type and the second having the second entity type. The inconsistency is resolved at block 514 in accordance with whether the inconsistency is determined to be a source error or an over conflation error.

There are multiple solutions to resolve an inconsistency when it is detected. In an aspect, these solutions could be used individually, in combination, or in series. For example, in one aspect, the following solutions are used in series such that if the first solution doesn't work, the second solution is tried. If the second solution does not work, the third solution is tried, and so on. In this aspect, when an inconsistency is determined to be based on a source error, it may be determined whether one data source is more authoritative than another data source. If this can be determined, the data from the less authoritative data source could be removed from the knowledge base. If it is not determined that one data source is less authoritative than another data source, the inconsistent data point may be removed if there are more data points in the knowledge base that are consistent with a data point not determined to be inconsistent than with the data point that is flagged as potentially being inconsistent. If there are not more data points in the knowledge base that are consistent with the other data point than with the data point, the method includes determining that data samples from one or more third-party data sources indicate that the other data point is accurate. If, on the other hand, the inconsistency is determined to be based on an over conflation error and not a source error, the resolving comprises separating the entity into two or more entities in the knowledge base.

In one aspect, threshold values are used to determine whether a value is inconsistent or not, or to determine whether to discard a value determined to be inconsistent. For instance, in an aspect, a data value may be discarded when the data point is outside a determined threshold or interval. For instance, a threshold could be determined. A value of a data point may be directly compared to a threshold, or a value of a data point may be compared to a value of another data point that has not been flagged as being inconsistent. If this difference is below the threshold, the data point may be inconsistent.

In another aspect, automatically detecting an inconsistency of a data point in the knowledge base may comprise identifying one or more data points that are properties associated with the entity. For instance, a property could be a date, a time, a length, a height, etc. Pairs of properties that correspond to one another could be identified, such as in the case of dates, times, and other numeric values. Based on values of the pairs of properties, an interval may be generated. The interval, in one aspect, is computed by first computing a mean value in distance as a first interval value and a standard deviation as a second interval value. Other methods for computing an interval are contemplated to be within the scope of aspects herein. As such, when a value of a data point is within the computed interval, it may be considered to be consistent. When a value is outside the computed interval, it may be flagged as being inconsistent.

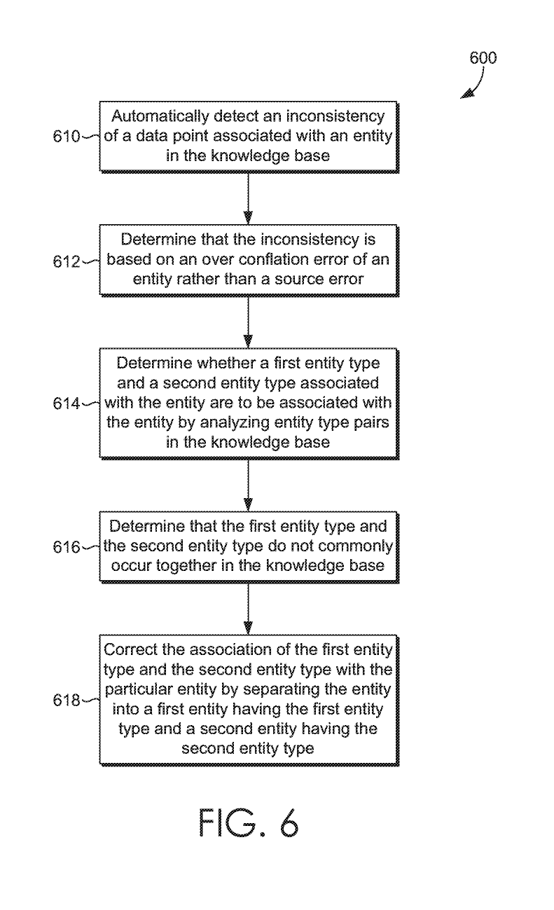

Turning to FIG. 6, FIG. 6 illustrates a flow diagram of another method 600 for mitigating inconsistency errors in a knowledge base, in accordance with aspects of the technology described herein. At block 610, an inconsistency of a data point associated with an entity in a knowledge base is automatically detected. An entity is an instance of an abstract concept or object. At block 612, it is determined that the inconsistency is based on an over conflation error of an entity rather than a source error. At block 614, for the entity in the knowledge base associated with the data point, it is determined whether a first entity type and a second entity type associated with the entity are supposed to be associated with the entity. This may be done by analyzing entity type pairs in the knowledge base to determine whether the first and second entity types commonly occur together.

At block 616, it is determined that the first entity type and the second entity type do not commonly occur together in the knowledge base. This could be done by, for example, determining a correlation between the first and second entity types in the knowledge base. The correlation could be, for example, a percentage such that if the first and second entity types commonly occur together or have a high correlation, the percentage would be relatively high (e.g., greater than 80%, 85%, 90%, 95%, 99%). To the contrary, two entity types that do not commonly occur together and that have a low correlation would have a low percentage (e.g., less than 20%, 15%, 10%, 5%, 1%). Based on this, the association of the first and second entity types with the entity is corrected, shown at block 618. This correction, in an aspect, is done by separating the entity into a first entity having the first entity type and a second entity having the second entity type. For example, if the original entity is a particular person who is associated with an entity type “person” and also with an entity type “book,” it would likely be found by surveying the knowledge base that a person is not also a book in most cases, and thus the person entity type should be separated from the book entity type. The over conflation of an entity may occur when two entities were erroneously associated with one another or when a first entity type was associated with a second entity type to create a single entity erroneously. This would, in some cases, come from data from multiple sources.

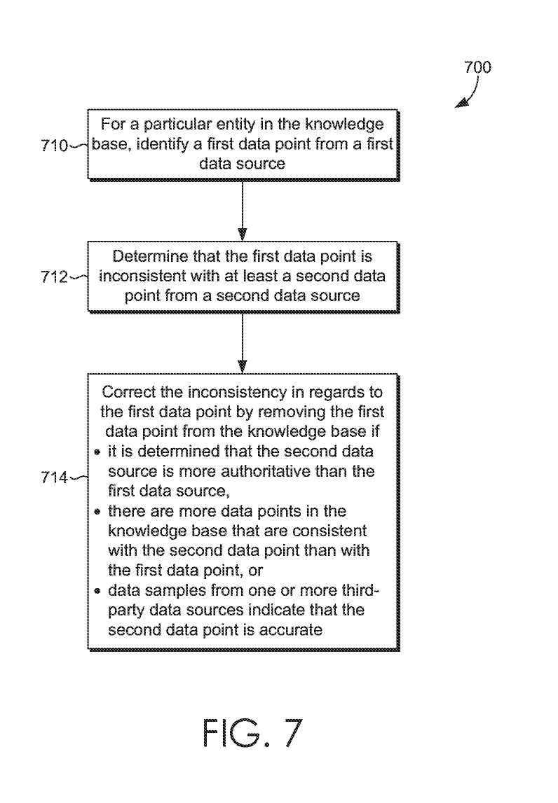

FIG. 7 illustrates a flow diagram of another method 700 for mitigating inconsistency errors in a knowledge base, in accordance with aspects of the technology described herein. At block 710, for a particular entity in a knowledge base, a first data point from a first data source is identified. At block 712, it is determined that the first data point is inconsistent with at least a second data point from a second data source. The inconsistency is corrected at block 714 in regards to the first data point by removing the first data point from the knowledge base upon one of several circumstances. Initially, if it is determined that the second data source is more authoritative than the first data source, the first data point may be removed from the data source. If, however, that cannot be determined, if there are more data points in the knowledge base that are consistent with the second data point than with the first data point, the first data point may be removed from the knowledge base. If, however, that cannot be found or determined, data samples from one or more third-party data sources could be collected to provide an indication as to whether the second data point is accurate. Once collected from these sources, if a majority or some other threshold of data points are pointing to the same value, this could be used as an indication as to whether or not a data point is inconsistent or not.

In aspects, a threshold is used to determine that a first data point is inconsistent with a second data point from a different source. A threshold value may be determined. A value of the first data point may be compared to the value of a second data point to determine whether a difference between the values is below the determined threshold. If the difference is below the threshold, the first data point may be considered to be consistent. If the difference is not below the threshold value, or above the threshold value, the first data point may be inconsistent.

### Exemplary Operating Environment

In FIG. 8, an exemplary operating environment for implementing aspects of the technology described herein is shown and designated generally as computing device 800. Computing device 800 is but one example of a suitable computing environment and is not intended to suggest any limitation as to the scope of use of the technology described herein. Neither should the computing device 800 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, and an illustrative power supply 822. Bus 810 represents what may be one or more busses (such as an address bus, data bus, or a combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 8 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or nonvolatile memory. The memory 812 may be removable, non-removable, or a combination thereof. Exemplary memory includes solid-state memory, hard drives, optical-disc drives, etc. Computing device 800 includes one or more processors 814 that read data from various entities such as bus 810, memory 812, or I/O components 820. Presentation component(s) 816 present data indications to a user or other device. Exemplary presentation components 816 include a display device, speaker, printing component, vibrating component, etc. I/O ports 818 allow computing device 800 to be logically coupled to other devices, including I/O components 820, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 814 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 800. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include a radio 824. The radio 824 transmits and receives radio communications. The computing device may be a wireless terminal adapted to receive communications and media over various wireless networks. Computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Aspects of the technology have been described to be illustrative rather than restrictive. It will be understood that certain features and subcombinations are of utility and may be employed without reference to other features and subcombinations. This is contemplated by and is within the scope of the claims.

The invention claimed is:

1. A computing device comprising:
at least one processor; and
memory having computer-executable instructions stored thereon that, based on execution by the at least one processor, configure the at least one processor to mitigate inconsistency errors in a knowledge base by being configured to:
automatically detect an inconsistency of a data point associated with an entity in the knowledge base;
determine whether the inconsistency is based on a source error or an over conflation error of an entity,
resolve the inconsistency in accordance with determining whether the inconsistency is the source error or the over conflation error,
wherein when the inconsistency is determined to be based on a source error, the resolving comprises:
(1) removing the inconsistent data point if it is determined that a data source from which the data point originated is less authoritative than another data source from which another data point originated,
(2) if it is not determined that the data source is less authoritative than the other data sources, removing the inconsistent data point if there are more data points in the knowledge base that are consistent with the other data point than with the data point, and
(3) if there are not more data points in the knowledge base that are consistent with the other data point than with the data point, determining that data samples from one or more third party data sources indicate that the other data point is accurate, and
wherein when the inconsistency is determined to be based on an over conflation error, the resolving comprises separating the entity into two or more entities in the knowledge base.

2. The computing device of claim 1, wherein the inconsistency of the data point associated with an entity in the knowledge base is automatically detected when the data point is not in compliance with a predetermined rule.

3. The computing device of claim 1, wherein the inconsistency is determined to be based on the source error when the data point is associated with a single data source.

4. The computing device of claim 1, wherein the inconsistency is the over conflation error when the data point is associated with a plurality of data sources.

5. The computing device of claim 1, wherein the data point is at least one of a value, a property, a relationship between two entities, or an association between a first entity type, a second entity type, and an entity.

6. The computing device of claim 1, wherein the over conflation error occurs when an entity is erroneously associated with both a first entity type and a second entity type, and wherein the over conflation error occurs when different entities are merged into a single entity.

7. The computing device of claim 1, wherein the source error occurs when the data point comprises incorrect data from a data source.

8. The computing device of claim 1, further comprising prior to removing the inconsistent data point, determining that a value associated with the data point is outside a determined threshold.

9. The computing device of claim 1, wherein automatically detecting the inconsistency further comprises:
determining a threshold value; and
comparing a value of the data point from the data source to a value of the other data point from the other data source to determine whether a difference between the values is below the threshold value, wherein:
if the difference is not below the threshold value, the data point is inconsistent, and
if the difference is below the threshold value, the data point is not inconsistent.

10. The computing device of claim 1, wherein automatically detecting the inconsistency of the data point associated with the entity in the knowledge base further comprises:
identifying one or more data points that are properties associated with the entity;
identifying pairs of the properties that correspond to one another; and
based on values of the pairs of the properties, generating an interval for each of the pairs by computing a mean value in distance as a first interval value and a standard deviation as a second interval value,
wherein the data point is automatically detected as being inconsistent when a value associated with the data point is within the interval.

11. A method for mitigating inconsistency errors in a knowledge base, the method comprising:
automatically detecting an inconsistency of a data point associated with an entity in the knowledge base;
determining that the inconsistency is based on an over conflation error of an entity rather than a source error;
for the entity in the knowledge base associated with the data point, determining whether a first entity type and a second entity type associated with the entity are to be associated with the entity by analyzing entity type pairs in the knowledge base to determine whether the first entity type and the second entity type commonly occur together;
determining that the first entity type and the second entity type do not commonly occur together in the knowledge base; and
correcting the association of the first entity type and the second entity type with the particular entity by separating the entity into a first entity having the first entity type and a second entity having the second entity type.

12. The method of claim 11, where the determining whether a first entity type and a second entity type associated with the particular entity are to be associated with the particular entity further comprises determining a correlation between the first entity type and the second entity type in the knowledge base.

13. The method of claim 11, wherein the entity is an instance of an abstract concept or an object.

14. The method of claim 11, wherein the inconsistency is based on the over conflation of the entity when the entity is erroneously associated with both a first entity type and a second entity type, which occurs when different entities are merged into a single entity.

15. A method for mitigating inconsistency errors in a knowledge base, the method comprising:
for a particular entity in the knowledge base, identifying a first data point from a first data source;
determining that the first data point is inconsistent with at least a second data point from a second data source; and
correcting the inconsistency in regards to the first data point, wherein the correcting comprises removing the first data point from the knowledge base if:
(1) it is determined that the second data source is more authoritative than the first data source,
(2) there are more data points in the knowledge base that are consistent with the second data point than with the first data point, or
(3) data samples from one or more third-party data sources indicate that the second data point is accurate.

16. The method of claim 15, wherein if it is not determined that the second data source is more authoritative than the first data source, determining whether there are more data points in the knowledge base that are consistent with the second data point than with the first data point.

17. The method of claim 16, wherein if there are not more data points in the knowledge base that are consistent with the second data point than with the first data point, then determining that data samples from one or more third-party data sources indicate that the second data point is accurate.

18. The method of claim 15, wherein determining that the first data point is inconsistent with at least the second data point from the second data source further comprises:
determining a threshold value; and
comparing a value of the first data point from the first data source to a value of the second data point from the second data source to determine whether a difference between the values is below the threshold value, wherein:
if the difference is not below the threshold value, the first data point is inconsistent, and
if the difference is below the threshold value, the first data point is not inconsistent.

19. The method of claim 15, wherein correcting the inconsistency in regards to the first data point comprises deleting the first data point from the knowledge base.

20. The method of claim 19, wherein when the first data point is deleted from the knowledge base, it is saved in a repository that stores deleted data from the knowledge base.
